(19) United States
(12) Patent Application Publication
(10) Pub. No.: US 2008/0174075 A1
(43) Pub. Date: Jul. 24, 2008

(54) Cylinder Head Gasket

(75) Inventors: Armin Diez, Lenningen (DE); Frank Schaible, Esslingen (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ELRINGKLINGER AG, Dettingen/Erms (DE)

(21) Appl. No.: 11/630,408

(22) PCT Filed: Jul. 6, 2005
(86) PCT No.: PCT/EP2005/007270

§ 371 Date: Oct. 30, 2007

(30) Foreign Application Priority Data
Jul. 14, 2004 (DE) 10 2004 033 906.6

(51) Int. Cl. F16J 15/08

(52) U.S. Cl. 277/595

(57) ABSTRACT

The invention relates to a cylinder head gasket comprising a gasket unit (10), which has at least one through opening, particularly a combustion chamber opening (12), and which has at least two interacting gasket plies (18, 20, 22) of which one (18, 20) is provided with a flexible bead (26, 28) encircling the through opening, and the other (22) is provided with a device (34) that limits this flexibility. Said device (24) has, on opposite sides (34, 38), alternating recesses (30) and elevations (32) whereby a recess (30) is located, at least partially, opposite an elevation (32). At least a portion of the recesses (30) and of the elevations (32) have an essentially trapezoidal cross-section with sloped delimiting walls (36) extending between the adjacent recesses (30) and elevations (32) of one side (34 or 38) of gasket ply (22), and the adjacent opposite delimiting walls (36) of both sides (34, 38) delimit a web cross-section (SQ1) of gasket ply (22) that is greater than or equal to the web cross-section (SQ2) delimited between the opposite recesses (30) of both sides (34, 38).

The invention relates to a cylinder head gasket with a seal unit which has at least one through opening, especially a combustion chamber opening, and which has at least two sealing layers interacting with one another, of which one is provided with at least one resilient bead which encompasses the through opening and the other is provided with a device which limits this resilience and which on opposing sides has in alternation depressions and elevations such that at least in part one depression is opposite one elevation.

EP-A-1 298 365 discloses a metallic cylinder head gasket with a seal plate having at least one combustion chamber opening as a seal unit which has at least two metal sheet metal layers, of which a first one is provided with at least one elastically, vertically deformable bead which encompasses the combustion chamber opening and a second one is provided with at least one deformation limitation means which encompasses the combustion chamber opening and which limits bead deformation. To achieve the most rigid deformation limitation possible, in the known solution the original second sheet metal layer is formed by a steel sheet which can be ductilely deformed by cold extrusion and the limitation means in an elevational view of the second sheet metal layer forms a two-dimensional pattern of discrete stamped depressions, the total volume of the depressions prepared by extrusion being at least roughly equal to the total volume of the elevations formed by the material of the second sheet metal layer displaced when the depressions are prepared. This known seal solution has very good sealing properties; preparation of the two-dimensional pattern on individual stamped recesses is, however, very complex in terms of production engineering and accordingly cost-intensive.

WO 01/96768 discloses a cylinder head gasket which is made as a flat seal with at least one metallic layer in which at least one through opening (combustion chamber opening) is formed. This or at least one of the metallic layers is formed at least in certain regions in the form of corrugated or sawtooth profiling around the respective combustion chamber opening, and at least the layer in which profiling is formed, based on the required very high elasticity limits, must consist of spring steel, the profiling having a deformation limitation means for an additionally formed bead which is not crimped over.

In the past, rigid limitation means (stoppers) of conventional design, such as for example rings or folded sheets welded onto the sealing layer, exhibit a very low elastic portion which is limited to fractions of microns due to the high modulus of elasticity of the steels used for this purpose for the compressions present in the engine region. Practical tests have shown that this stiff behavior can result in a nonuniform compression distribution in the region of the combustion chamber. In the known solution with corrugated or sawtooth profiling, also in trapezoidal form, based on the thinly stamped crosspiece cross sections for an alternating succession of elevations and depressions in the sealing layer (profiling), especially elastic behavior with simultaneously reduced surface compression is achieved. Furthermore uniform compression over the stopper width is effected by the elastic response of the individual corrugations.

JP 11-108191 discloses a generic cylinder head gasket which for implementation of the limitation means (stopper) for one of the sealing layers generally omits a corrugated or sawtooth profile, but rather uses a stopper block which is formed as a block in cross section and which has elevations and depressions with a rectangular cross section, offset to one another on opposite sides in an alternating sequence. Based on the resulting enlarged crosspiece cross sections the limitation means (stopper) is made very stiff in behavior; this likewise relieves the respective bead seal. Solely based on the sharp-edged transitions between an elevation and following depression breaking off of sealing elements is possible. Accordingly the known solution proposes eliminating this disadvantage by adding fluorinated rubber material as plastic with soft material behavior to the depressions. This measure is in turn complex and expensive in implementation and it cannot be precluded that in the operational situation the added soft material is unintentionally leached out.

On the basis of this latter prior art the object of the invention to further improve the known cylinder head gaskets while retaining their advantages such that while avoiding corrugated and sawtooth profiling for the sealing layer with the limitation means (stopper), a seal solution is devised for which harmful compression peaks and still a very stiff configuration which is favorable in production and reliable in application is implemented. This object is achieved by a cylinder head gasket with the features of claim 1 in its entirety.

In that, as characterized in the characterizing part of claim 1, at least some of the depressions and elevations are essentially trapezoidal in cross section, with limitation walls which run obliquely between adjacently configured depressions and elevations of one side of the other sealing layer and because the limitation walls of two sides adjacently opposite one another border a crosspiece cross section of the other sealing layer which is greater than or equal to the crosspiece cross section delineated between the opposing depressions of these two sides, based on the obliquely running limitation walls the application of force to the free crosspiece cross sections of this sealing layer is favorable and otherwise the crosspiece cross sections are enlarged in terms of their dimensions compared to the most similar generic solution, such that not only are the sealing elements prevented from unintentionally breaking off in the stopper region, but the limitation means with its elevations and depressions also has a very stiff behavior; this ensures that the bead which at least primarily assumes the sealing function is protected against excess deformations in engine operation.

It is surprising to a person with average skill in the art in the field of cylinder head gaskets that while avoiding corrugated or sawtooth profiling, also in trapezoidal form, and with formation of the limitation means (stopper) as a stiffly designed block part, he obtains a balanced distribution of compression while avoiding harmful compression peaks on the combustion chamber opening in order in this way to obtain pronounced elastic-plastic behavior with simultaneously reduced surface compression to ensure the sealing function of the entire cylinder head gasket.

Since the solution as claimed in the invention to implementation of a limitation means (stopper) does not use corrugated or sawtooth profiling, the use of spring steels, which are difficult to work and due to their elastic behavior can only contribute to a minor degree to stiffening of the limitation means, can be abandoned. The solution as claimed in the invention rather proceeds from the principle, based on a block-like limitation means structure by a plastic forming process, especially in the form of an extrusion process, such as cold extrusion, of stamping in an alternating sequence depressions and elevations into a block structure in order in this way to obtain significant changes of the strength properties of the material, generally hardness, fracture strength, and yield points increasing. In this instance strength properties are obtained which are equivalent to those of alloyed steels. For very high stresses it has been found that the fatigue strength and thus also the durability of cold extruded workpieces are much higher than for comparable workpieces of spring steel. Based on the strength properties which have been improved in this way, in spite of the depressions formed, a very stiff overall structure is obtained for the limitation means which accordingly can effectively relieve the actual sealing means with the beads in place in the cover layers of the stressed sealing combination.

Especially for limitation means which are made with thin walls in the region of the middle transition from two adjacently opposite depressions of different sides of the limitation means, extensive plasticization of the material is achieved with the indicated advantages of an increase in strength and stiffness, conversely the edge-side regions with a smaller degree of forming can still have elastic properties comparable to the spring steels used in limitation means in corrugated or sawtooth form. It is thus possible with the solution claimed in the invention within the scope of a cold extrusion forming process to effectively combine the advantages of plastic forming in the base of the attachment means with those of elastic material properties in the direction of the respective top of the limitation means (stopper) with one another and in this way to set them.

Other advantageous embodiments of the cylinder head gasket as claimed in the invention are the subject matter of the dependent claims.

The cylinder head gasket as claimed in the invention will be detailed below using one embodiment as shown in the drawings. The figures are schematic and not to scale.

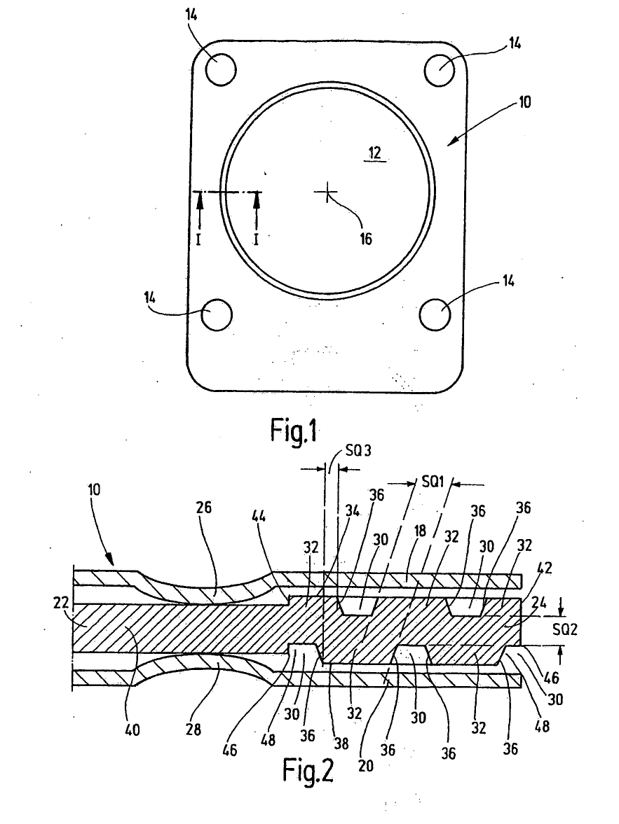

FIG. 1 shows an elevational view of part of the cylinder head gasket as claimed in the invention with only one combustion chamber opening;

FIG. 2 shows a section along line I-I in FIG. 1.

FIG. 1 shows a cylinder head gasket with a seal unit designated as a whole as 10, which is composed of three metal layers (compare FIG. 2) and from which as through openings at least essentially a round combustion chamber opening 12 and screw passage openings 14 for passage of the corresponding fastening screws (not shown) have been left open. Of the possible combustion chamber openings of an internal combustion engine, for the sake of simplicity, FIG. 1 accordingly shows only a single one with a longitudinal axis designated as 16.

The seal unit 10 is composed essentially of an upper first sealing layer 18, a correspondingly designed lower sealing layer 20 as the third sealing layer; and a second middle sealing layer 22 which is provided on its side facing the combustion chamber opening 12 with a limitation means (stopper) 24. The upper sealing layer 18 and the lower sealing layer 20 are each provided on their side facing away from the limitation means 24 with a bead 26, 28, made as a so-called solid bead. Sealing of the combustion chamber opening 12 in addition to the pertinent combustion chamber against the escape of combustion gases takes place via the beads 26, 28 which are made in the shape of circular rings in the two metal layers 18 and 20. The indicated beads run concentrically to the combustion chamber opening 12 and must be spring-elastically deformable with the cylinder head gasket installed in operation of the internal combustion engine for the purpose of a flattening perpendicular to the middle sealing layer 22 so that to achieve the pertinent flexibility, preferably the two sealing layers 18, 20 are made from sheet metal material, especially spring steel sheet metal.

In an embodiment which is not detailed, it can also be provided that the respective beads 26, 28 follow a path which is not closed in itself, but sealing being effected for example only in segments over definable distances. In addition to the indicated circular ring shape, other curves of shapes are possible also, for example in the form of a meander structure, in the shape of an oval and the like. Furthermore, the respective bead 26, 28 need not be configured concentrically to the longitudinal axis 16 of the combustion chamber opening 12, but can also run off-center.

So that the two beads 26 and 28 are not unduly deformed in operation, for example deformed such that they can at least no longer fully perform their sealing function, there is a limitation means (stopper) 24 on the middle sealing layer 22. This limitation means 24 is located radially within the beads 26, 28 with respect to the axis 16 of the combustion chamber opening 12; but it could also be located radially outside these beads or it would be possible to provide this stopper 24 both radially within and also outside of these beads. Furthermore the two beads 26, 28 need not be exactly opposite in one plane upon contact with the middle sealing layer 22; rather a corresponding lateral offset would also be conceivable here. In order to achieve the interaction of the bead 26 or 28 with the stopper 24, it is however necessary for these components of the cylinder head gasket to be mounted adjacent to one another.

As is to be seen in FIG. 1, the limitation means 24 in the form of a circular ring which is concentric to the longitudinal axis 16 encompasses the combustion chamber opening 12, the width of the limitation means 24 being constant. For an embodiment which is not detailed, it would also be possible to vary the width of the stopper 24 around the combustion chamber opening in order in this way to obtain a stopper profiled in width. In an embodiment which is not shown for the purposes of profiling of the stopper in width, on at least one side it can be provided with a convex arch which preferably forms a crowned contact surface which can optionally also contribute in this way to increasing the sealing action.

The outer layers consist preferably of a cold deformable steel which hardens during tempering and the middle sealing layer 22 consists preferably of a cold-workable steel. Preferably in the cylinder head gasket solution claimed for the invention the depressions 30 and the elevations 32 in the area of the limitation means 24 are obtained not be deep-drawing, but by extrusion, especially cold extrusion. The shaping tool (not show) has mold walls which corresponds to the outside contour of the limitation means 24 with its depressions 30 and elevations 32, and the mold jaws of the shaping tool which form the depressions 30 displace the metal of the middle sealing layer 22 in the direction of the elevations 32 with formation of the latter. As a result of the trapezoidal configuration of the shaping jaws of the shaping tool which is not detailed here, the cross sectional shapes of the depressions 30 and elevations 32 are trapezoidal, in the shape of an isosceles trapezoid, at least relative to the shape in the middle region of the limitation means 24. It is within the ambit of the invention to make the trapezoidal cross sectional shapes with limitation walls 36 running at least partially convex and/or concave, for example comparably to gear flanks in conventional gears (not shown). Furthermore, preferably the depressions 30 are all made equally deep and in this way border the groove-shaped paths. Preferably it is furthermore provided that the base of the respective groove of a depression 30 is made equal in width to at least one depression 30 in the immediately adjacent area.

In that at least the portion of the depressions 30 and elevations 32 located in the middle in cross section is trapezoidal with limitation walls 36 which run obliquely between adjacent depressions 30 and elevations 32 of one side 34 or 38 of the other middle sealing layer 22 and in that the adjacently opposite limitation walls 36 of two sides 34, 38 border one crosspiece cross section SQ1 which is equal to, but preferably larger than, the crosspiece cross section SQ2 which is delineated between the opposing depressions 30 of these two sides 34, 38, a very stiffly designed limitation means 24 is formed, in which failure can be precluded based on the optimum application of force along the oblique limitation walls 36 (preferably made with an angle of inclination of less than 25°) or in their region. This is also promoted by the fact that, viewed parallel to the longitudinal axis 16, the adjacent depressions 30 have a radial distance from one another such that a further third crosspiece cross section SQ3 remains, the crosspiece cross sections being dimensioned such that SQ1 is greater than SQ2 and SQ2 is greater than SQ3. These crosspiece cross sections are shown by way of example and imaginary in FIG. 2 with broken lines. If the free ends of the elevations 32 are calibrated accordingly, instead of the trapezoidal shape in the initial state also a barrel-shaped configuration can result.

In particular by the cold extrusion process used as claimed in the invention the material cross sections in the region of SQ2 can be largely or completely formed in a ductile manner between two depressions 30 adjacently opposite on different sides 34, 38.

Since the oblique limitation walls 36 of two adjacent depressions 30 are tilted toward one another on opposing sides 34, 38 of the stopper 24 radially in both directions, this yields an additional support effect for the limitation means 24. The depressions 30 and the elevations 32 are likewise configured running along concentric circles to the middle of the combustion chamber opening 12. The elevations 32 on one side 34 or 38 of the other middle sealing layer 22 run along a common plane which projects opposite an assignable plane along which the other parts 40 of this sealing layer 22 run. Preferably the middle sealing layer 22 with its other parts 40 is integrally connected to the limitation means 24. For an embodiment which is not detailed it is also possible to profile the limitation means vertically, i.e., in this case then not all elevations are the same height. In this way the compression around the combustion chamber opening can be set in a defined manner and especially also made uniform by way of the vertical profiling, so that for example distortion of the cylinder associated with the combustion chamber opening can be prevented.

The limitation means 24 on its side 42 facing the combustion chamber opening 12 as well as on its side 44 which is facing the other parts 40 of the middle sealing layer 22 establishes a shoulder-like transition 46 to a depression 48 which is implemented at least partially in the shape of a trapezoid and exact adaptation to circumstances can be achieved as a result of the accompanying reduction in the height of the middle sealing layer 22 in this respect with fundamental stiffening of the stopper 24 configured as a block. In order to further stiffen and stabilize the limitation means 24, for an embodiment which is not detailed it can also be provided that at least some of the depressions 30 of the middle sealing layer 22 be filled, preferably with a fluorinated rubber material.

Furthermore it is possible in an embodiment which is not further detailed to allow the upper sealing layer 18 or the lower sealing layer 20 to be omitted and then each side 38 and 34 which is opposite to be supported on the housing parts of the engine or of the cylinder head. In two-ply seals such as these, the sheet metal layer provided with the stopper must then be so thin, at least in the region of the bead to be protected, that the compression increase caused by the bead in an annular region can also act on the side of the seal opposite the bead.

1. A cylinder head gasket with a seal unit (10) which has at least one through opening, especially a combustion chamber opening (12), and which has at least two sealing layers (18, 20, 22) interacting with one another, of which one (18, 20) is provided with at least one resilient bead (26; 28) which encompasses the through opening and the other (22) is provided with a means (24) which limits this resilience and which on opposing sides (34, 38) has in alternation depressions (30) and elevations (32) such that at least in part one depression (30) is opposite one elevation (32), characterized in that at least some of the depressions (30) and elevations (32) in cross section are essentially trapezoidal, with limitation walls (36) which run obliquely between adjacently configured depressions (30) and elevations (32) of one side (34 or 38) of the other sealing layer (22) and that the limitation walls (36) of two sides (34, 38) adjacently opposite one another border a crosspiece cross section (SQ1) of the other sealing layer (22) which is greater than or equal to the crosspiece cross section (SQ2) delineated between the opposing depressions (30) of these two sides (34, 38).

2. The cylinder head gasket as claimed in claim 1, wherein the depressions (30) and the elevations (32) run along definable paths, especially along concentric circles to the middle of the combustion chamber opening (12).

3. The cylinder head gasket as claimed in claim 2, wherein the cross sections of depressions (30) and elevations (32) form at least partially isosceles trapezoids, to the extent the initial state before start-up is addressed.

4. The cylinder head gasket as claimed in claim 1, wherein the elevations (32) on one side (34, 38) of the other sealing layer (22) run along a common plane which projects opposite an assignable plane along which the other parts (40) of this sealing layer (22) run.

5. The cylinder head gasket as claimed in claim 1, wherein the limitation means (24) in cross section is made in the form of a rectangular limitation block and wherein especially by a ductile forming process such as extrusion the elevations (32) are formed at least partially from the material from the depressions (30) displaced in the process.

6. The cylinder head gasket as claimed in claim 1, wherein with the formation of at least one crowned contact surface the limitation means (24) on at least one side (34, 38) has a convex arch.

7. The cylinder head gasket as claimed in claim 5, wherein the limitation means (24) on its side (40) facing the through opening (combustion chamber opening 12) as well as on its side (44) which is facing the other parts (40) of the other sealing layer (22) establishes a shoulder-like transition (46) to a depression (48) which is implemented at least partially as a trapezoid.

8. The cylinder head gasket as claimed in claim 1, wherein there is a further third sealing layer (20) with a bead (28), wherein the two facing beads (26, 28) of one sealing layer and the other (18, 20) can be brought into contact under pretensioning with the other sealing layer (22) located in between, and wherein in the region of the elevations (32) and depressions (30) of the other sealing layer (22) the first and the other sealing layers (18, 20) assume an axial distance to them.

9. The cylinder head gasket as claimed in claim 1, wherein a filling material in the form of a soft material, for example a heat-resistant plastic material, preferably a fluorinated rubber material, can be placed in some of the depressions (30) of the other sealing layer (22).
